(19) United States
(12) Patent Application Publication
(10) Pub. No.: US 2023/0240808 A1
(43) Pub. Date: Aug. 3, 2023

(54) OPTIMIZED INDIRECT BONDING TRAY SYSTEM

(71) Applicant: uLab Systems, Inc., Memphis, TN (US)

(72) Inventors: Louis SCHUELLER, Redwood City, CA (US); Henry CAO, San Jose, CA (US); Andrew LIU, Burnaby (CA); Rooz KHOSRAVI, Memphis, TN (US)

(73) Assignee: uLab Systems, Inc., Memphis, TN (US)

(21) Appl. No.: 18/150,091

(22) Filed: Jan. 4, 2023

Related U.S. Application Data
(60) Provisional application No. 63/267,498, filed on Feb. 3, 2022.

(51) Int. Cl. A61C 7/14

(52) U.S. Cl. CPC A61C 7/146

(57) ABSTRACT

Optimized indirect bonding tray systems are described where an hybrid IDB tray apparatus may generally comprise an orthodontic shell configured to conform to a dentition of a patient and one or more modules incorporated along the orthodontic shell and where each of the one or more modules defines a recess configured to removably retain a bracket. Each recess may open along the orthodontic shell to position the bracket against a surface of a crown.

### CROSS-REFERENCE TO RELATED APPLICATIONS

The present application claims the benefit of priority to U.S. Prov. App. 63/267,498 filed Feb. 3, 2022, which is incorporated herein by reference in its entirety.

### FIELD OF THE INVENTION

The present invention relates to methods and apparatus for orthodontics. More particularly, the present invention relates to methods and apparatus for the positioning of orthodontic brackets upon teeth using indirect bonding trays and facilitating the removal of the trays in orthodontic treatments.

### BACKGROUND OF THE INVENTION

Orthodontics is a specialty of dentistry that is concerned with the study and treatment of malocclusions which can result from tooth irregularities, disproportionate facial skeleton relationships, or both. Orthodontics treats malocclusion through the displacement of teeth via bony remodeling and control and modification of facial growth.

A typical treatment generally involves the placement and positioning of braces upon the teeth of a patient for the purpose of applying a static mechanical force to induce bone remodeling, thereby enabling teeth to move. Braces utilize orthodontic brackets affixed to each tooth and an archwire interface interfacing with each of the brackets. As the teeth respond to the pressure applied via the archwire by shifting their positions, the wires are again tightened to apply additional pressure. Each of the brackets are typically aligned in a pre-planned location on each tooth to ensure that tightening of the archwire will result in a desirable tooth movement. While the brackets may be manually positioned and secured to each respective tooth, this is a time-consuming process.

Orthodontists and other practitioners may utilize a flexible orthodontic appliance called an indirect bonding tray which enables the practitioner to load an entire arch of brackets into the tray, then quickly transfer those brackets onto the dentition in their planned positions. These trays may be created by utilizing a positive mold of a patient's dentition which may be created from an orthodontic 3D scan. Hence the tray may be customized to each particular patient's dentition. These trays may also be transparent to allow for the practitioner to use to curing light to cement the entire arch of brackets simultaneously.

However, there are also deficiencies with many of these indirect bonding tray systems. For instance, some trays may not yield the adequate resolution to provide for accurate placement of the brackets upon the teeth. Many of the trays may provide for inadequate space for clearing of excess adhesive used in securing the brackets to the teeth surface. Furthermore, many trays result in bonding failures between the bracket and teeth surface when attempting to remove the tray from the dentition. These bonding failures may be aggravated by the presence of protrusions such as integral hooks (such as an integral ball hook) or hooks for banding which extend from the bracket away from the arch wire slot which may make tray removal difficult.

Accordingly, there exists a need for an efficient and effective indirect bonding tray which facilitates placement of orthodontic brackets.

### SUMMARY OF THE INVENTION

Indirect bonding (IDB) trays may be used for the placement of orthodontic brackets in a controlled manner to minimize the risk of bracket placement errors and to facilitate the bonding process. The IDB trays described herein may also be used with any number of other teeth planning treatment systems such as those produced by Align Technologies, Inc. (San Jose, Calif.).

Through the use of orthodontic aligner design software, the digital models of individual modules of the IDB tray which are conformed to the patient-specific dentition may be incorporated with the digital model of an orthodontic shell which is also conformed to the patient-specific dentition through an additive Boolean operation to create a singular, integrated IDB tray and orthodontic shell combination. The digital models of individual IDB modules may be incorporated directly with the digital model of the orthodontic shell to create a singular orthodontic shell having the IDB modules which may be fabricated as a single hybrid tray appliance. When the hybrid IDB tray is placed upon the dentition such that the crowns are positioned within the receiving cavity, each of the brackets contained within the modules are positioned in their desired locations upon each respective crown surface.

Because the orthodontic shell is conformed directly to the anatomy of the patient's teeth, the hybrid IDB tray may be readily placed upon the dentition ensuring that each of the IDB modules are accurately positioned upon the respective crown surface in their pre-treatment positions. The accurate positioning of the modules allows for the orthodontic appliance within the modules, such as brackets, to be accurately positioned and secured to the surfaces of the respective crown for treatment. Also, the conformed orthodontic shell allows for the modules and brackets to be securely held in place while preventing their inadvertent movement during securement.

Each of the individual modules are formed to create a recess within which each respective bracket pad may be securely held for placement upon the patient's crowns. Because the modules may be customized for each patient's anatomy and individual treatment plan, the recesses may be accordingly customized for various different bracket types where the bracket types can be varied along the same hybrid IDB tray. One or more recesses within the modules may optionally incorporate a retention feature for removably securing the brackets within the recess. One example may include a protrusion or projection along one or more inner walls of the recess which may abut against the bracket for securing its position. Additionally and/or alternatively, grooves or channels may also be defined along one or more inner walls of the recess for facilitating alignment of the bracket within the recess. The incorporation of such securement and/or alignment features may help to enhance accurate positioning of the bracket upon the crown and may also enhance formation of the bond between the bracket and the crown during placement.

Each of the modules may further define an opening along each gingival surface of the module to facilitate removal of the hybrid IDB tray from the patient's dentition once the bracket pads have been secured to the teeth. The openings may further provide access to the bracket pads within the recesses via an instrument or insertion tool (e.g., explorer, scaler, etc.) which may be inserted into the opening to access the bracket pad or to facilitate removal of the module from the surface of the crown and secured bracket.

The hybrid IDB tray may be formed to extend along any desired length of the dentition arch where a bracket or other orthodontic appliance is to be secured. The hybrid IDB tray may be formed to extend back towards the second molar of the patient's dentition (e.g., 7/ or /7 under the Palmer notation). Moreover, either side of the arch may be formed to extend to different lengths depending upon the treatment to be applied to the patient.

Some or all of the receiving cavities may incorporate one or more securement features defined along the inner surface of the cavities for helping to secure the hybrid IDB tray to the dentition and to also prevent movement of the hybrid IDB tray relative to the teeth. The securement features may include one or more protrusions or projections or dimples which extend from the recess walls and project to grip onto the surfaces of the teeth when the hybrid IDB tray is worn upon the teeth. In one variation, the securement features may be located within the orthodontic shell receiving cavity for securement against the crowns of molar 6 and/or 7, while in other variations, the securement features may be located within any number of cavities. Furthermore, the securement features may be positioned to project on both sides of the cavity so as to apply a gripping force evenly on both the lingual and buccal surfaces of the crown so that an unintended movement of the teeth is inhibited.

In addition to facilitating securement of the hybrid IDB tray to the patient's dentition, the hybrid IDB tray may be also configured to follow best fit bite plane of the patient's dentition. The flat surface of the hybrid IDB tray opposite to where the modules are integrated may be formed parallel to the bite plane of the patient. Having the hybrid IDB tray formed parallel to the bite plane may reduce the amount of the material used in creating the hybrid IDB tray to save on material waste and also to improve the fit and comfort when the hybrid IDB tray (either upper dentition, lower dentition, or both upper and lower dentition) is worn by the patient during bracket placement.

Yet another feature of the hybrid IDB tray which may be optionally incorporated relates to the tray interface with the gingival margin along the lingual side of the patient's dentition. The crown generally forms a natural undercut along the gingival margin as illustrated between the crown and gums. The hybrid IDB tray may be configured and designed to follow the specific gingival interface of the patient along the lingual side such that the hybrid IDB tray forms a tray interface which curves to interface against the natural undercut and follows along the gingival interface.

This tray interface helps to secure the hybrid IDB tray into this natural undercut and further allows for a reduction in the amount of material used to form the hybrid IDB tray by keeping the hybrid IDB tray relatively thinner along the lingual side of the tray than would the amount of material which would normally be used by existing IDB products.

In reducing the amount of material along the lingual side of the hybrid IDB tray, the securement of the hybrid IDB tray may be facilitated by the tray interface taking advantage of the natural undercut along the gingival margin. The amount of material along the occlusal surface of the hybrid IDB tray may be determined by forming a line or initial plane along the occlusal surfaces. This initial plane may be angled from the incisors to the molars to reposition the plane such that the difference between angled plane and initial plane may represent the amount of material which may be removed from the hybrid IDB tray resulting in an appliance having a reduced amount of material without a reduction in performance. In this manner, the occlusal surface of the hybrid IDB tray may remain flattened while the amount of material along the incisors may be removed in greater amounts than the amount of material along the molars.

While the planes are illustrated as having been angled from the incisors to the molars, the planes may be angled in the opposite direction from the molars to the incisors in other variations such that relatively more material is removed along the molars rather than the incisors of the hybrid IDB tray. Yet another variation may have the plane simply adjusted uniformly rather than at an angle to reduce the amount of material along the entire occlusal surfaces of the hybrid IDB tray.

With individual modules aligned adjacently along the orthodontic shell, the hybrid IDB tray may be adjusted in its rigidity, for instance, either its overall rigidity or along specified regions of the orthodontic shell in between adjacent modules. In one variation, the portion of the orthodontic shell between adjacent modules may be reduced in thickness to reduce the local rigidity of the orthodontic shell to increase flexibility and comfort for the patient. As the portions of the orthodontic shell between the modules may impart a minimal amount of force upon the adjacent crowns, the thickness of the portion may be reduced relative to the thickness of the rest of the orthodontic shell so that the portions of the orthodontic shell which contact the dentition may flex by a greater amount than if the thickness remained unchanged along portion.

One or more regions of the hybrid IDB tray may be varied in thickness to have relatively thinner regions and/or relatively thicker regions such that the flexibility of the orthodontic shell and hybrid IDB tray may be adjusted to become more rigid and/or less rigid overall or more rigid and/or less rigid along select regions depending upon the desired flexibility. For instance, while one region may be reduced in thickness, another region may be similarly reduced in thickness by the same amount or a different amount and the hybrid IDB tray may incorporate one or more regions having varied thickness, as desired.

Additionally and/or alternatively, the portions of the orthodontic shell which extend between the adjacent crowns may be configured to closely follow the dentition along both the buccal and lingual sides of the orthodontic shell. With the orthodontic shell following the anatomy of the patient's dentition, additional features may be incorporated or defined along the inner walls of the orthodontic shell to ensure retention of the orthodontic shell upon the dentition where portions of the orthodontic shell may extend between the interproximal regions of the teeth. One or more of these interproximal regions may also incorporate a retention feature which may extend along the region and project away from the orthodontic shell wall such that the retention feature abuts between the two adjacent surfaces of the crowns to further secure the hybrid IDB tray relative to the teeth.

While the retention feature may be formed as having a curved surface, the feature may present any number of shapes which are conducive for securement within the interproximal regions of the teeth. Moreover, the feature may extend along the entire length of the interproximal region or just a portion and the feature may be defined along any one or more of the regions along the orthodontic shell. For example, in a region where adjacent teeth may have a relatively larger gap, such a feature may be incorporated to ensure that the orthodontic shell is secured within the gap. Any of the retention features may also be incorporated as part of the hybrid IDB tray material itself or any of the retention features may be attached as a separate element within the hybrid IDB tray.

As the hybrid IDB tray may be fabricated through, for instance, additive manufacturing such as three-dimensional printing, the hybrid IDB tray may be formed to have a flattened surface. The flattened surface may facilitate the additive printing process as the hybrid IDB tray may be fabricated upon a platform allowing for the indirect bonding tray to be built up from the flattened surface. As the indirect bonding tray may be used to accurately position and secure orthodontic devices such as brackets upon the surfaces of the teeth, the occlusal surfaces of the indirect bonding tray may be formed to have the flattened surface common to the entire hybrid IDB tray as the hybrid IDB tray may be removed from the patient's dentition once the bracket pads have been secured to the teeth.

Each of the individual modules may be formed to create a recess within which each respective bracket pad may be securely held for placement upon the patient's crowns. Because the modules may be customized for each patient's anatomy and individual treatment plan, the recesses may be accordingly customized for various different bracket types where the bracket types can be varied along the same hybrid IDB tray. One or more recesses within the modules may optionally incorporate an occlusal retention feature designed specifically for a particular style of bracket for maintaining a position of the bracket within the recess and relative to the crown surface for positioning and securement.

The occlusal retention feature may be positioned along an occlusal surface within the recess and project proximally (e.g., in a gingival direction or towards the gingiva when in use) to form a shoulder or tapered surface which provides a retention region for securement against the bracket pad. The retention feature may secure a position of the bracket pad within the recess during placement and securement against the crown surface. Once the bracket pad has been secured to the dentition, the retention feature may slide away from the bracket to release the bracket and allow for the removal of the hybrid IDB tray from the patient's teeth.

The hybrid IDB tray may also define access lumens along the occlusal flattened surface of each module for providing access to within the recess, for example, for providing access to a bracket or other orthodontic appliance contained within when the access tray is positioned upon the patient's teeth. One or more instruments may be introduced through the access lumen for accessing the bracket pad contained within for any number of procedures such as adjusting a bracket, cleaning the bracket or excess adhesive, facilitating removal of the hybrid IDB tray from a bracket and/or from the teeth of the patient, etc.

Each of the access lumens may have its edges optionally angled or filleted to create a curved interface. The base layer filleting may be digitally created so as to create the fillets or chamfer in order to improve the printability of the hybrid IDB tray.

As each of the edges and openings along the hybrid IDB tray may be configured to create a fillet to increase printability, the overall reduction of material also reduces the base-layer flash material in fabricating the tray. Moreover, the curved edges may also facilitate instrument entry and removal from the access lumens.

Each of the modules may also define an access opening along a gingival side opposite to the occlusal flattened surface to allow access within the recess for any number of instruments. Some or all of the modules along the hybrid IDB tray may include the access opening.

Furthermore, the access openings may be sized to allow for the bracket pad within to pass through the access opening as the hybrid IDB tray is removed from the patient dentition. If the access opening is sized relatively smaller than the bracket positioned within the recess, the module may be flexed partially away from the bracket pad during removal of the hybrid IDB tray using, for instance, an instrument.

While the hybrid IDB tray may be fabricated as a complete singular appliance, other variations may include hybrid IDB trays which are fabricated as two or more separate components. One variation of an hybrid IDB tray assembly may include several hybrid IDB tray segments which collectively form an entire hybrid IDB tray. The hybrid IDB tray segments may be digitally separated along separation planes which divide each of the hybrid IDB tray segments from one another. Furthermore, the separation planes may be located between any of the teeth and while three individual segments are shown in this variation, other variations may have the hybrid IDB tray assembly separated into two separate segments or more than three segments as desired.

Having the hybrid IDB tray assembly separated into different segments allows for the individual segments to reduce the plane thickness which in turn helps to improve the handling of the individual segments for placement upon the teeth and removal from the teeth. For instance, the amount of material removed from the individual occlusal planes may be uniform between each of the segments or they may be varied between one or more of the segments resulting in varying heights.

Individual hybrid IDB tray segments may be each formed with occlusal plane heights which are different from one another. For instance, an occlusal plane of a first segment may be formed with a relatively low height due to more material being removed from the occlusal plane while the occlusal plane of a second segment may be formed with a relatively high height due to more material remaining in the fabrication of the segment while the occlusal plane of a third segment may be formed with a relatively intermediate height between the occlusal planes.

The relative heights of the occlusal planes of different segments may be varied depending upon the amount of material desired or needed for fabrication of the individual segment without sacrificing hybrid IDB tray performance. Hence, the different occlusal planes may be varied between the individual segments to be uniform or differing between one another.

In any of the variations described, the hybrid IDB tray may optionally incorporate an identification platform which may be fabricated as an integrated part of the hybrid IDB tray or as a separate identification platform which may be attached to a particular hybrid IDB tray. In this variation, the identification platform may be an integrated platform which extends from an anterior portion of the hybrid IDB tray along a lingual portion such that the surface of the platform extends along the occlusal surface of the hybrid IDB tray.

The surface of the identification platform may provide a place for identifying information to be displayed such as patient information, hybrid IDB tray information, etc.

Additionally or alternatively, the buccal and/or lingual surfaces of the module may include identifying information which may be engraved, embossed, or otherwise adhered for the tooth identification match with that particular module.

While individual features of the hybrid IDB tray are described in different embodiments, this is done for clarity purposes as any of the hybrid IDB trays described may incorporate any one or all of the various features described herein in a single hybrid IDB tray.

In one variation, the hybrid IDB tray apparatus may generally comprise an orthodontic shell configured to conform to a dentition of a patient and one or more modules incorporated along the orthodontic shell and where each of the one or more modules defines a recess configured to removably retain a bracket such that each recess opens along the orthodontic shell to position the bracket against a surface of a crown.

In one method of forming an hybrid IDB tray, the method may generally comprise receiving three-dimensional scanned data relating to a dentition of a patient to form a corresponding digital model of the dentition, determining a position of one or more brackets for placement upon the digital model of the dentition, digitally forming an orthodontic shell configured to conform to the dentition, digitally forming one or more modules corresponding to the position of the one or more brackets upon the dentition, and incorporating the one or more modules with the orthodontic shell to form an hybrid IDB tray.

### BRIEF DESCRIPTION OF THE DRAWINGS

FIGS. 1A and 1B show bottom and perspective views of one variation of an IDB tray formed into a full arch configuration.

FIGS. 2A and 2B show bottom and perspective views of the variation from FIGS. 1A and 1B having brackets positioned within their individual receiving channels for bonding to a respective tooth surface.

FIGS. 3A and 3B show perspective and top views of another variation of the IDB tray positioned upon the dentition of a patient.

FIGS. 3C, 3D, and 3E show respective side, back, and cross-sectional side views of the IDB tray placed upon the dentition.

FIGS. 4A to 4B show perspective and bottom views of yet another variation in which the IDB tray may incorporate break joints along the individual modules.

FIG. 5A shows a perspective view of the digital model of the hybrid IDB tray combination showing the digital models of individual IDB modules incorporated directly with the digital model of the orthodontic shell to create a singular indirect bonding tray.

FIG. 5B shows a detail perspective view of the individual modules which are formed to create a recess within which each respective bracket pad may be securely held for placement.

FIGS. 6A to 6C illustrate perspective, bottom, and top views of an hybrid IDB tray illustrating how the modules are formed integrally with the orthodontic shell and where each module is formed with an opening along each occlusal surface of the module.

FIGS. 7A and 7B illustrate perspective detail views where some or all of the receiving cavities may incorporate one or more securement features defined along the inner surface of the cavities.

FIG. 8 shows a side view of an hybrid IDB tray configured to follow best fit bite plane of the patient's dentition.

FIG. 9A shows a bottom detail view of the tray interface along the gingival margin of the lingual side.

FIG. 9B shows a partial cross-sectional side view illustrating how the tray interface may be configured to follow and interface with the gingival margin.

FIGS. 9C and 9D illustrate top and side views of an hybrid IDB tray showing how the lingual profile of the hybrid IDB tray may be further reduced.

FIGS. 10A and 10B illustrates a detail perspective view of the hybrid IDB tray showing how portions of the hybrid IDB tray may be varied in rigidity by altering thicknesses.

FIG. 10C illustrates a perspective view of the orthodontic shell and modules and the portions of the orthodontic shell which extend between the interproximal regions of the teeth.

FIG. 10D illustrates an example in the detail top view of how the retention feature may project away from the orthodontic shell wall for contact within the interproximal regions.

FIGS. 11A and 11B illustrate side and perspective views of an hybrid IDB tray formed to have a flattened occlusal surface.

FIG. 12 illustrates a detail perspective view of one or more recesses within the modules which may optionally incorporate an occlusal retention feature.

FIGS. 13A and 13B illustrate side views of how the retention feature may secure a position of the bracket pad within the recess.

FIGS. 14A to 14C illustrate detail top and bottom perspective views of the hybrid IDB tray and modules showing how the access lumens may extend through the occlusal flattened surface and through the orthodontic shell of each module.

FIG. 15 illustrates a perspective view of the access lumens having its edges optionally angled or filleted to create a curved interface.

FIG. 16 illustrates a detail perspective view of the modules which may define an access opening along a gingival side opposite to the occlusal flattened surface.

FIG. 17A shows a top view of one variation where an hybrid IDB tray assembly may include several hybrid IDB tray segments which collectively form an entire hybrid IDB tray.

FIGS. 17B and 17C show another bottom and front views of another variation of an hybrid IDB tray assembly where individual hybrid IDB tray segments are each formed with occlusal plane heights which are different from one another.

FIG. 18 shows a top view of an hybrid IDB tray having an identification platform.

FIG. 19 shows a perspective view of an hybrid IDB tray having identifying information upon one or more individual modules.

### DETAILED DESCRIPTION OF THE INVENTION

To facilitate the placement of brackets upon the teeth, an indirect bonding (IDB) tray may be applied upon the patient's dentition to simultaneously position multiple brackets upon the relevant crowns. However, the IDB tray may be also incorporated into an orthodontic shell which is designed to conform to the dentition of the patient so that the IDB tray may be aligned precisely upon each of the relevant crowns in their desired locations when the orthodontic shell is worn by the patient.

Variations of the IDB tray itself are first described where the IDB tray may be used for the placement of orthodontic brackets in a controlled manner to minimize the risk of bracket placement errors and to facilitate the bonding process. The IDB tray may formed through any number of fabrication processes (e.g., 3D printing, thermal forming, etc.) and the tray may be designed utilizing automated design software and forming processes such as those developed by uLab Systems, Inc. (Redwood City, Calif.) and further described in U.S. Pat. Pubs. 2017/0100207; 2017/0100208; 2017/0100209; 2017/0100210; 2017/0100211; 2018/0078347; 2018/0078343; 2018/0078344; 2018/0078335; 2017/0100214; 2020/0345459; 2021/0393376, each of which is incorporated herein by reference in its entirety. The IDB trays described herein may also be used with any number of other teeth planning treatment systems such as those produced by Align Technologies, Inc. (San Jose, Calif.).

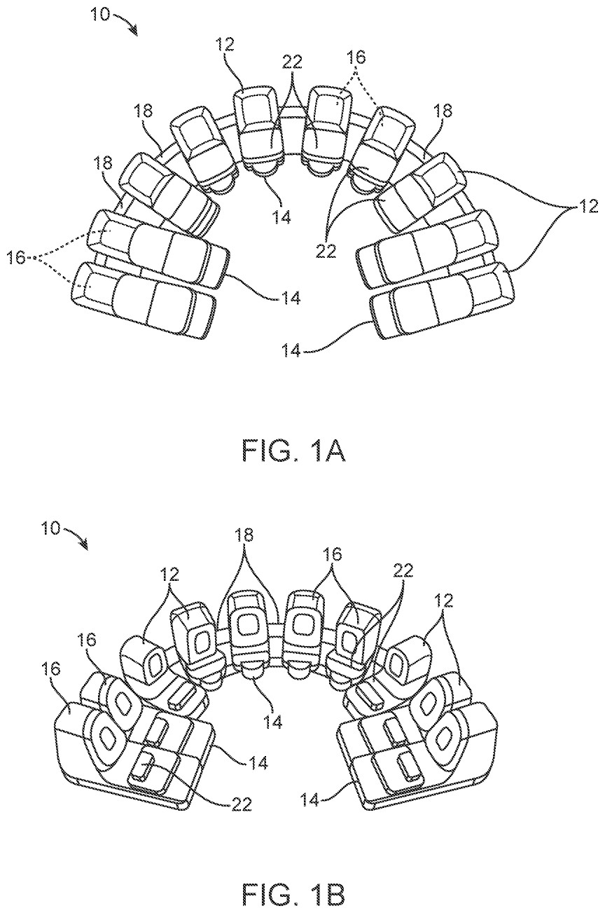

One variation of the IDB tray is shown in the bottom and perspective views of FIGS. 1A and 1B which illustrate an IDB tray 10 having a number of individual modules 12. The individual modules 12 may be connected to any number of adjacent modules in series to form a partial or complete arch depending upon the number of teeth upon which a bracket is to be bonded. Each of the modules 12 may define a receiving channel 16 within which a bracket may be placed prior to attachment to the tooth surface and the modules 12 may be attached to one another via one or more coupling members 18 which may be pre-formed to readily break when a force is applied.

Because the individual modules 12 may be formed for each crown that mates to a respective tooth using, e.g., buccal, lingual, and/or occlusal surfaces, any number of individual modules 12 may be removed from the IDB tray 10 depending upon the number of brackets to be applied. Thus, a single IDB tray 10 may be broken apart via the coupling members 18 to leave at least one individual module 12 for use or one or more individual modules 12 which may or may not be attached to one another for use, e.g., over different parts of the patient's dentition.

It is along the occlusal surface of the IDB tray 10 that the individual modules 12 are coupled to one another via a corresponding coupling member 18. If the practitioner desires bonding for fewer crowns, or if the crowns have moved since the patient's last visit, the coupling member 18 can be cut or broken by hand to allow for modular crown bonding individually, as part of a subset, or as the full set of brackets. The coupling members 18 may accordingly be formed to have a relative low thickness, e.g., 0.002 in., or they may be pre-formed with a weakened cross-section having recesses, notches, etc.

Each of the individual modules 12 may incorporate a corresponding reinforcing tab 22 which extends in apposition to each module 12 and functions as a gripping or securement backstop to hold an individual module 12 in position upon the patient's tooth or teeth. The reinforcing tab 22 may extend, e.g., in parallel, with the individual module 12 so that when the module 12 is positioned upon a buccal surface of the tooth with a bracket, the reinforcing tab 22 may extend at least partially or a full length upon a lingual surface of the same tooth to hold the module 12 in position over the buccal surface.

Additionally, each of the individual modules 12 may further incorporate a corresponding removal tab 14 which may extend from the individual module 12 and reinforcing tab 22 away from the buccal surface and parallel with the occlusal surface of the tooth or teeth such that the removal tab 14 is transversely positioned relative to the module 12, e.g., along the lingual-buccal axis of the crown. Each of the modules 12 may incorporate a removal tab 14 yet the lengths of the tab 14 may be varied for one or more of the modules 12 or the tabs 14 may be uniform in length between each module 12. In either case, the tab 14 may have a length, e.g., 3 to 4 mm, sufficient for the user to grasp or hold either manually or via a grasping instrument such as forceps.

An individual module 12 blank may be selected depending upon the crown for bonding upon. Also, the individual modules 12 may vary in size depending upon the location of the module upon the dentition. Modules 12 located posteriorly for placement upon, e.g., rear molars, may be dimensioned differently from modules 12 which are located anteriorly for placement upon, e.g., incisors. For instance, the rear module 12 for placement upon a molar may be formed to be relatively wider and longer, e.g., 15 to 20 mm in length and 5 to 8 mm in width, for placement upon molar and premolar crowns. Modules 12 which are designed for placement over incisors and bicuspids may be formed to have a width and length, e.g., 10 to 15 mm in length and 3 to 7 mm in width. The IDB tray 10 may be formed such that each of the individual modules 12 near their respective occlusal surfaces are formed to a common height (z-height) for easy and fast 3D printing.

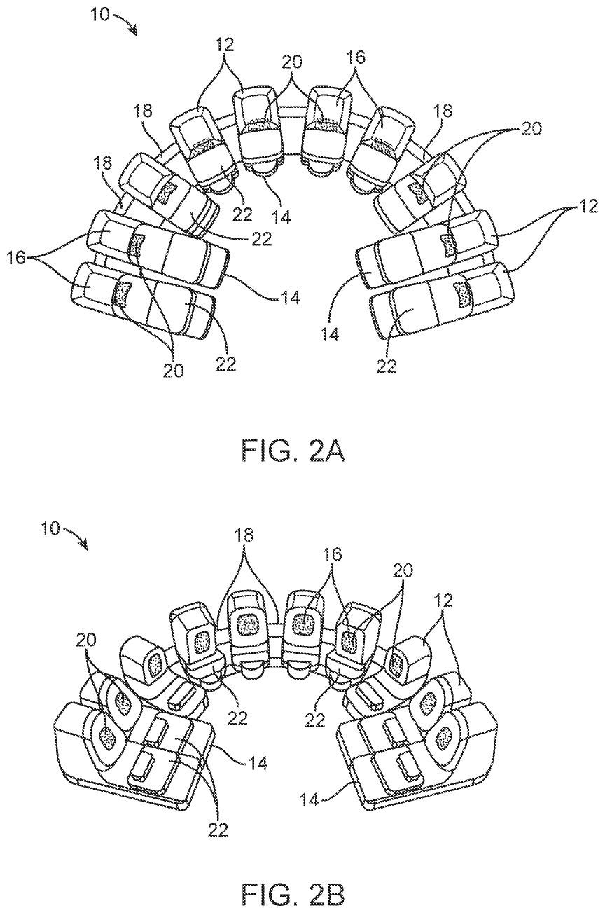

As shown in the bottom and perspective views of FIGS. 2A and 2B, the brackets 20 to be bonded to the surface of the teeth may be placed within their respective receiving channels 16 with their bonding surfaces positioned to be placed along the buccal side of the tooth or teeth. In other variations, a different geometry may be employed where the individual modules 12 are positioned along the lingual side of the dentition such that the respective receiving channels 16 are positioned on the lingual side to allow for lingual bracket placement.

As further shown, the IDB tray 10 may be formed of a transparent polymeric material which may allow for, e.g., a UV light, to be shined through the modules 12 once the IDB tray 10 and respective brackets 20 are in position over the patient's dentition. This may allow for the bonding agent to be cured through the IDB tray 10 to ensure that the brackets 20 are maintained in their relative positions over the surface.

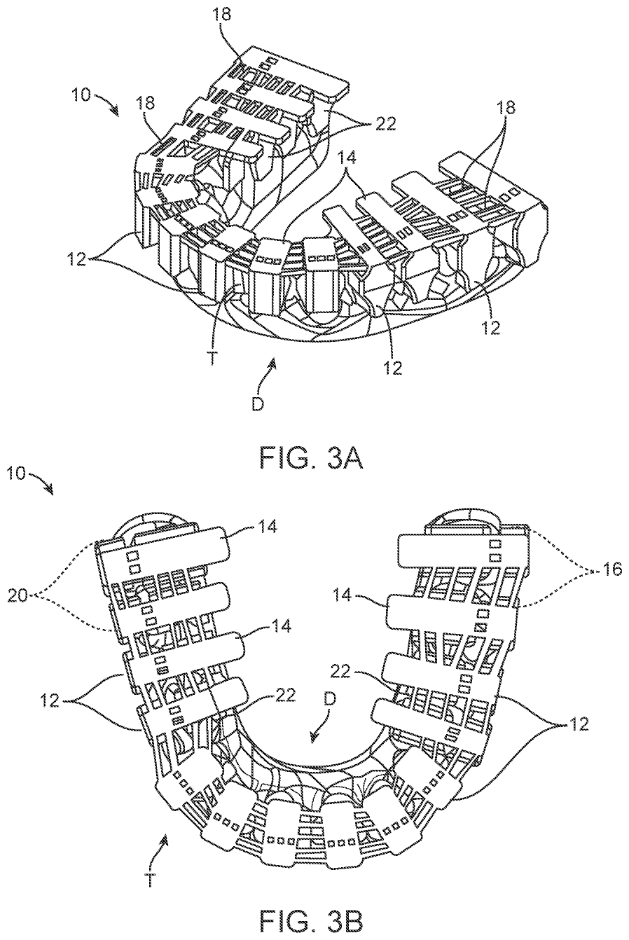

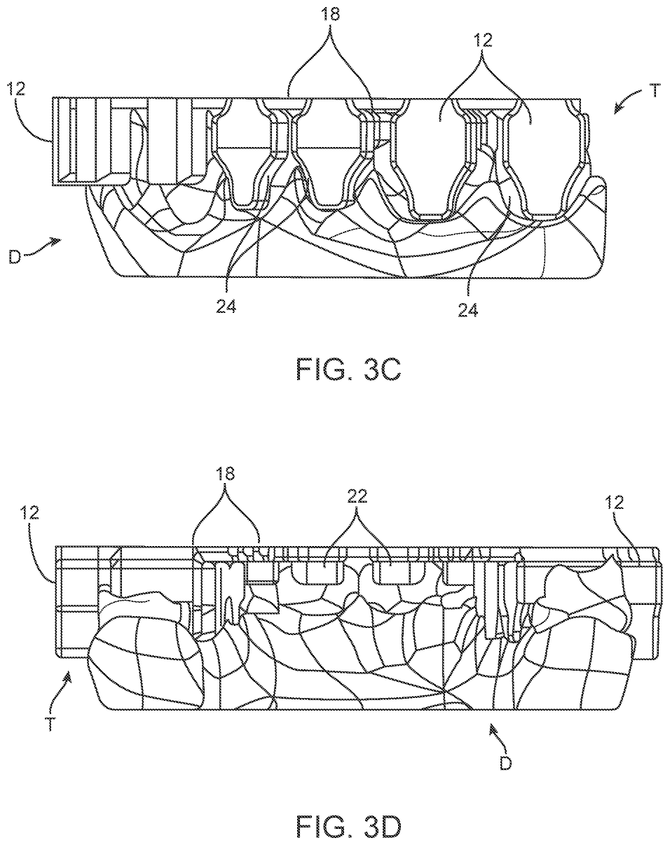

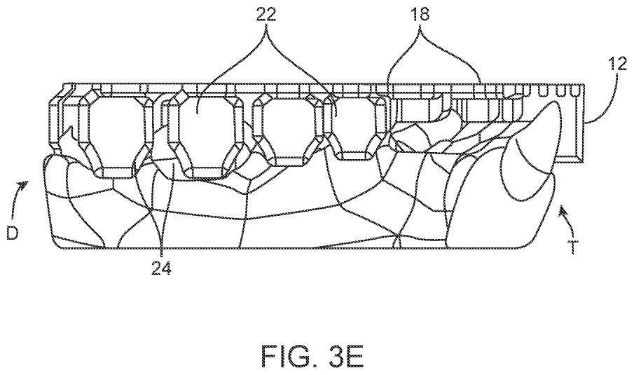

FIGS. 3A and 3B show examples of how the IDB tray 10 may be positioned upon the patient's dentition D for placing and securing the brackets 20. While the IDB tray 10 is illustrated as having a full arch which extends over the entirety of the patient's teeth T, one or more individual modules 12 may be utilized by breaking the coupling members 18 corresponding to one or both sides of the individual module or modules 12, as described herein. The occlusal side of the IDB tray 10 may be seen upon the dentition T such that they are positioned directly above the occlusal surfaces of the teeth T. Moreover, the occlusal surface of the IDB tray 10 is shown as having a flattened surface between each of the individual modules 12 for printing or forming purposes. However, the IDB tray 10 may be formed to have surfaces with alternative geometries, as desired.

Moreover, the removal tabs 14 of each individual module 12 may be seen extending away from their respective buccal surfaces and towards the interior of the arch. FIGS. 3C, 3D, and 3E show respective side, back, and cross-sectional side views of the IDB tray 10 placed upon the dentition D. FIGS. 3D and 3E in particular illustrate how the removal tabs 14 may extend inwardly of the arch in parallel with the occlusal plane and transverse to the individual modules 12. The respective reinforcing tabs 22 may also be seen extending in parallel with the individual modules 12 such that they may extend at least partially along the lingual surfaces of each respective tooth or teeth. As noted herein, the reinforcing tabs 22 may be swapped in position with the module 12 such that the module 12 is positioned into contact against the lingual surface and the reinforcing tab 22 is positioned into contact against the buccal surface.

Additionally, one or more of the modules 12 may be formed to have a reduced profile by removing excess material or forming the module 12 with the reduced profile between adjacent modules 12, particularly around the corners of the modules 12 in proximity to the gingiva when positioned upon the dentition. In one example, as shown throughout FIGS. 3A to 3E, one or more of the modules 12 may be formed with recesses or radiused portions 24 on either side of the module 12 such that the distal portions of the module 12 narrow relative to the rest of the module cross-section. These recessed or radiused portions 24 may provide additional space between the modules for accessing the underlying surface of the respective crown for cleaning debris or excess adhesive once the bracket has been applied.

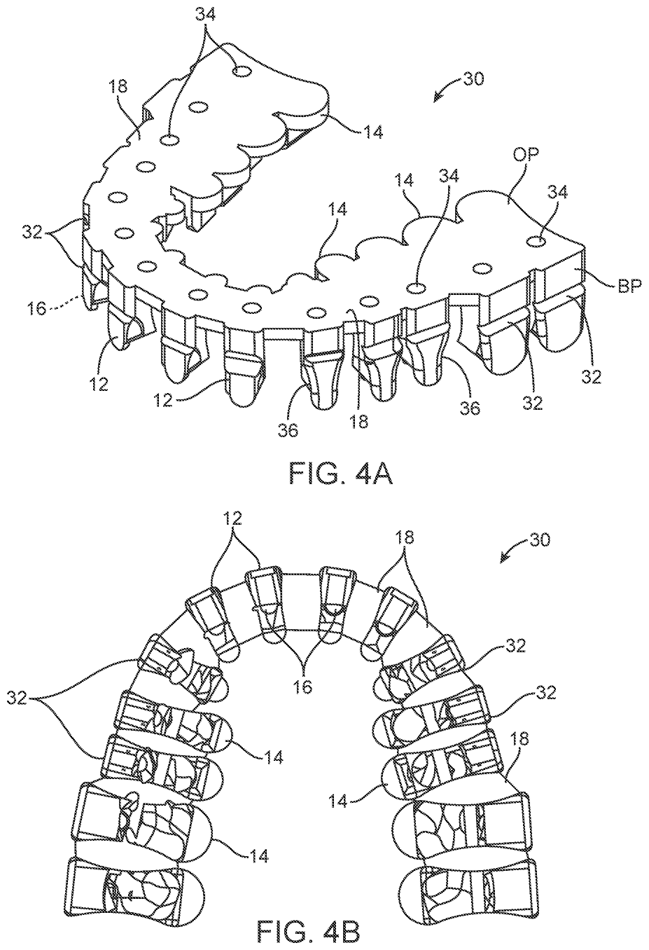

FIGS. 4A and 4B show perspective and bottom views of yet another variation of the IDB tray 30. In this embodiment, the individual modules 12 may have a reduced amount of material used such that the individual modules 12 have relatively more space between adjacent modules 12 and any crowding between the modules is reduced. Additionally, each of the modules 12 may have a break joint 32 located along the buccal plane BP and in proximity to the receiving channel 16. The occlusal side of the receiving channel 16 may also be opened to the occlusal plane OP through an access lumen 34.

Also shown are recessed or radiused portions 36, as described herein, on each of the individual modules 12 or at least one or more of the modules 12 which provide for increased space between adjacent modules 12 for clearing debris or removing any excess adhesive. While the recessed or radiused portions 76 are shown near the distal portions of the module 12 closest to the gingiva when in use upon the dentition, the recessed or radiused portions 36 may also be formed along the proximal portions of the modules 12 in proximity to the occlusal surfaces of the dentition when in use.

Turning now to the incorporation of the IDB tray with an orthodontic aligner-like shell, the creation of such orthodontic shells and variations of their design and fabrication are described in further detail in U.S. Pat. Pubs. 2017/0100207; 2017/0100208; 2017/0100209; 2017/0100210; 2017/0100211; 2018/0078347; 2018/0078343; 2018/0078344; 2018/0078335; 2017/0100214, each of which is incorporated herein above.

Hybrid IDB Tray Additive Boolean

Through the use of orthodontic aligner design software, as described above, the digital models of individual modules of the IDB tray which are conformed to the patient-specific dentition may be incorporated with the digital model of an aligner-like orthodontic shell which is also conformed to the patient-specific dentition through an additive Boolean operation to create a singular, integrated tray and aligner combination.

In forming the aligner-like orthodontic shell conformed to the patient's specific dentition, three-dimensional scan data of the dentition may be received by the computer to create a digital model of an aligner-like orthodontic shell which conforms to the scanned dentition. A treatment plan may be digitally determined for correcting any malocclusions or other issues with respect to the dentition and the appropriate locations for placement of any orthodontic appliances such as brackets for bracket-wire treatments upon the teeth may be determined. With the bracket locations determined based upon the treatment for correction of the dentition, the bracket positioning may be located upon each relevant crown with the teeth in their initial pre-treatment position based upon the scanned digital model. The individual modules may be digitally formed around the bracket positions upon the teeth in their pre-treatment locations and the modules may then be integrated in an additive process with the aligner-like orthodontic shell to form a digital model of a singular aligner-like IDB tray or a hybrid IDB tray where the modules for bracket positioning are integrated directly with the aligner-like orthodontic shell which is conformed to the patient dentition. The digital model may then be used to fabricate the hybrid IDB tray using any number of the manufacturing methods such as additive printing, thermoforming, etc.

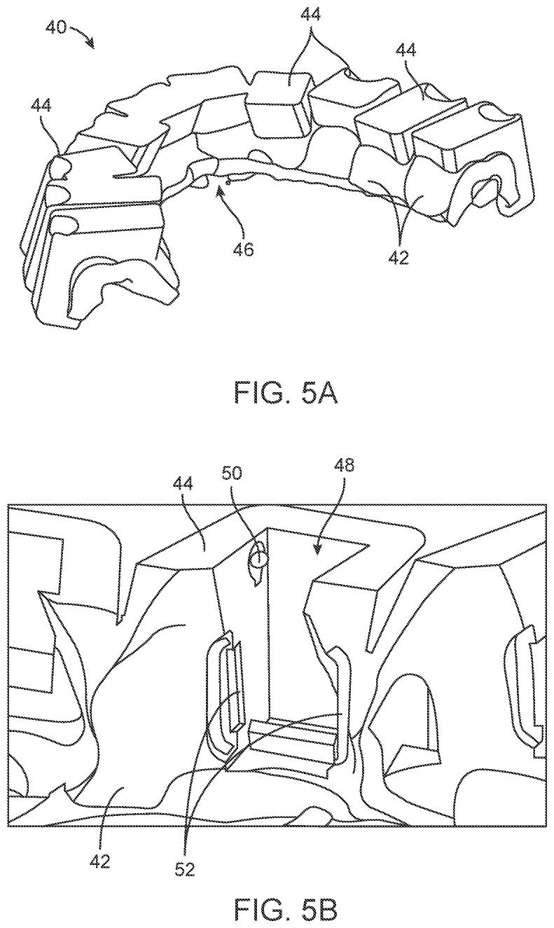

FIG. 5A illustrates a perspective view of the digital model of the hybrid IDB tray combination 40 showing the digital models of individual IDB modules 44 incorporated directly with the digital model of the orthodontic shell 42 to create a singular hybrid IDB tray having the IDB modules 44 which may be fabricated as a single appliance. When the hybrid IDB tray 40 is placed upon the dentition such that the crowns are positioned within the receiving cavity 46, each of the brackets contained within the modules 44 are positioned in their desired pre-treatment locations upon each respective crown surface.

Because the orthodontic shell 42 is conformed directly to the anatomy of the patient's teeth, the hybrid IDB tray 40 may be readily placed upon the dentition ensuring that each of the IDB modules 44 are accurately positioned upon the respective crown surface. The accurate positioning of the modules 44 allows for the orthodontic appliance within the modules 44, such as brackets, to be accurately positioned and secured to the surfaces of the respective crown at their pre-treatment locations. Also, the conformed orthodontic shell 42 allows for the modules 44 and brackets to be securely held in place while preventing their inadvertent movement during securement.

As described herein and as shown in the detail perspective view of FIG. 5B, each of the individual modules 44 are formed to create a recess 48 within which each respective bracket pad may be securely held for placement upon the patient's crowns. While the variation shows the modules 44 formed along the buccal surfaces of the orthodontic shell such that the recesses 48 open against the buccal surfaces of the orthodontic shell 42, other variations may incorporate the modules 44 formed along the lingual surfaces of the orthodontic shell 42 such that the recesses 48 open against the lingual surfaces of the orthodontic shell 42. Additional variations may include an orthodontic shell 42 having modules 44 formed along both buccal and lingual sides of the orthodontic shell 42 or where an orthodontic shell 42 may include some modules 44 formed along select buccal sides and other modules 44 formed along select lingual sides of the same orthodontic shell 42 depending upon the selected treatment.

Because the modules 44 may be customized for each patient's anatomy and individual treatment plan, the recesses 48 may be accordingly customized for various different bracket types where the bracket types can be varied along the same hybrid IDB tray 40. As further illustrated, one or more recesses 48 within the modules 44 may optionally incorporate a retention feature for removably securing the brackets within the recess 48. One example may include a protrusion or projection along one or more inner walls of the recess 48 which may abut against the bracket for securing its position or one or more recesses 50 which are defined along the one or more inner walls to accommodate features of a bracket positioned within the recess 48 such as the end of the hook of a bracket. Additionally and/or alternatively, grooves or channels 52 may also be defined along one or more inner walls of the recess 48 for facilitating alignment of the bracket within the recess 48. The incorporation of such securement and/or alignment features may help to enhance accurate positioning of the bracket upon the crown and may also enhance formation of the bond between the bracket and the crown during placement.

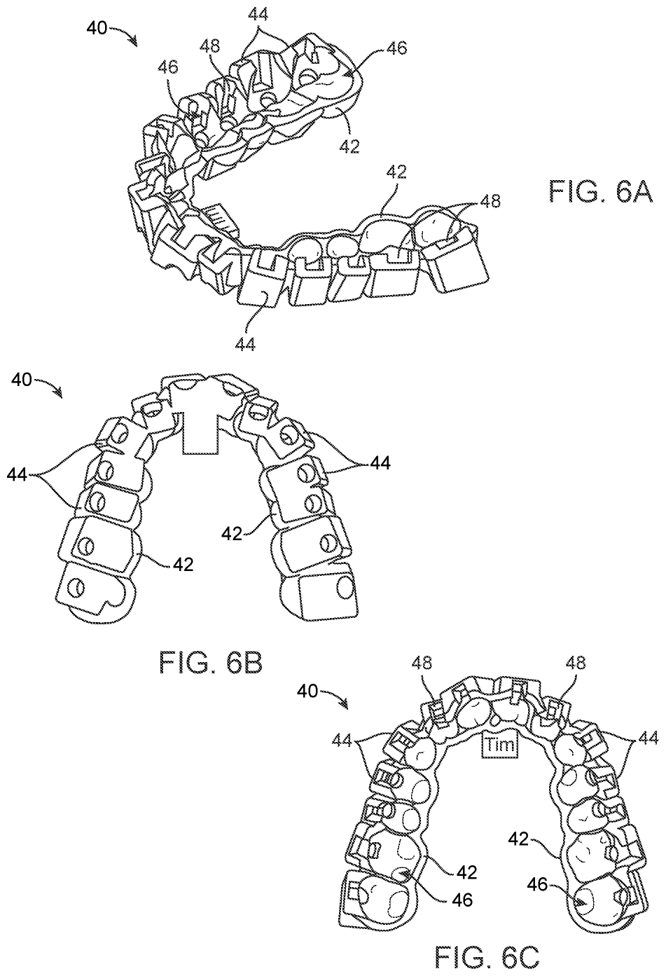

Each of the modules 44 may further define an opening along each gingival surface of the module 44 to facilitate removal of the hybrid IDB tray 40 from the patient's dentition once the bracket pads have been secured to the teeth. FIGS. 6A to 6C illustrate perspective, bottom, and top views of hybrid IDB tray 40 illustrating how the modules 44 are formed integrally with the orthodontic shell 42 and where each module 44 is formed with an opening along each gingival surface of the module 44. With the openings so positioned, the hybrid IDB tray 40 may be pulled off of the patient's dentition so that the bracket pads that are bonded to the surfaces of the crowns may remain undisturbed and the hybrid IDB tray 40 may be slipped off the teeth without having to excessively flex or bend the hybrid IDB tray 40.

Additionally, the openings may further provide access to the bracket pads within the recesses 48 via an instrument or insertion tool (e.g., scaler) which may be inserted into the opening to access the bracket pad or to facilitate removal of the module 44 from the surface of the crown and secured bracket. While the variation illustrates the modules 44 integrated and formed along a buccal side of the orthodontic shell 42 and patient dentition, the modules 44 may be optionally integrated and formed along a lingual side of the orthodontic shell 42 instead.

As further illustrated, the hybrid IDB tray 40 may be formed to extend along any desired length of the dentition arch where a bracket or other orthodontic appliance is to be secured. The variation shown illustrates how the hybrid IDB tray 40 may be formed to extend back towards the second molar of the patient's dentition (e.g., 7/ or /7 under the Palmer notation). Moreover, while the variation illustrates both sides of hybrid IDB tray 40 extending towards the second molar, either side of the arch may be formed to extend to different lengths depending upon the treatment to be applied to the patient.

Dimpled Securement Feature

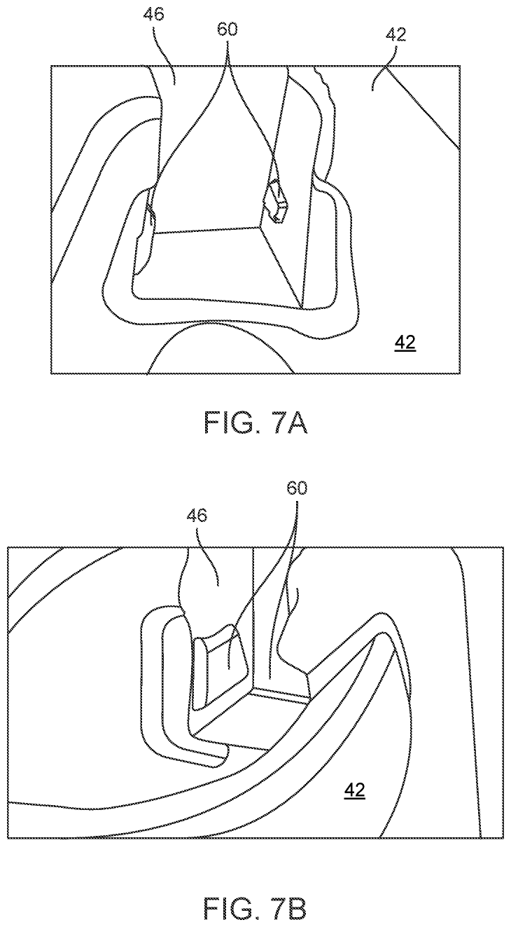

As further illustrated in the perspective detail views of FIGS. 7A and 7B, some or all of the receiving cavities 46 may incorporate one or more securement features 60 defined along the inner surface of the cavities 46 for helping to secure the hybrid IDB tray 40 to the dentition and to also prevent movement of the hybrid IDB tray 40 relative to the teeth. The securement features 60 may include one or more protrusions or projections or dimples which extend from the recess walls and project to grip onto the surfaces of the teeth when the hybrid IDB tray 40 is worn upon the teeth. In one variation, the securement features 60 may be located within the aligner receiving cavity 46 for securement against the crowns of molar 6 and/or 7, while in other variations, the securement features 60 may be located within any number of cavities. Furthermore, the securement features 60 may be positioned to project on both sides of the cavity 46 so as to apply a gripping force evenly on both the lingual and buccal surfaces of the crown so that an unintended movement of the teeth is inhibited.

Best Fit Bite Plane

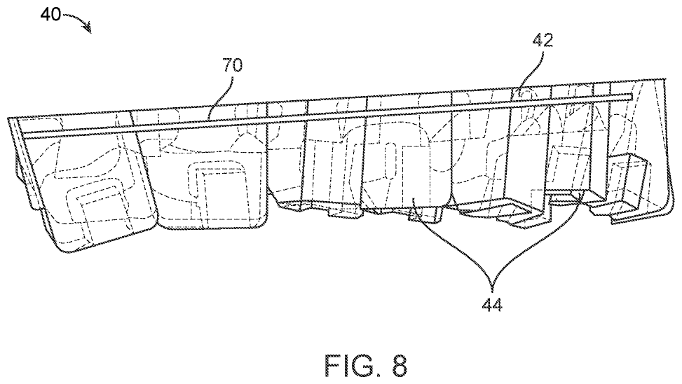

In addition to facilitating securement of the hybrid IDB tray 40 to the patient's dentition, the hybrid IDB tray 40 may be also configured to follow best fit bite plane 70 of the patient's dentition, as shown in the side view of FIG. 8. The hybrid IDB tray 40 is illustrated with an example of a side view of the bite plane 70 superimposed upon the hybrid IDB tray 40 for illustrative purposes. As shown, the flat surface of the hybrid IDB tray 40 opposite to where the modules 44 are integrated may be formed parallel to the bite plane 70 of the patient. Having the hybrid IDB tray 40 formed parallel to the bite plane 70 may reduce the amount of the material used in creating the hybrid IDB tray 40 to save on material waste and also to improve the fit and comfort when the hybrid IDB tray 40 (either upper dentition, lower dentition, or both upper and lower dentition) is worn by the patient during bracket placement.

Lingual Gingival Margin Coverage

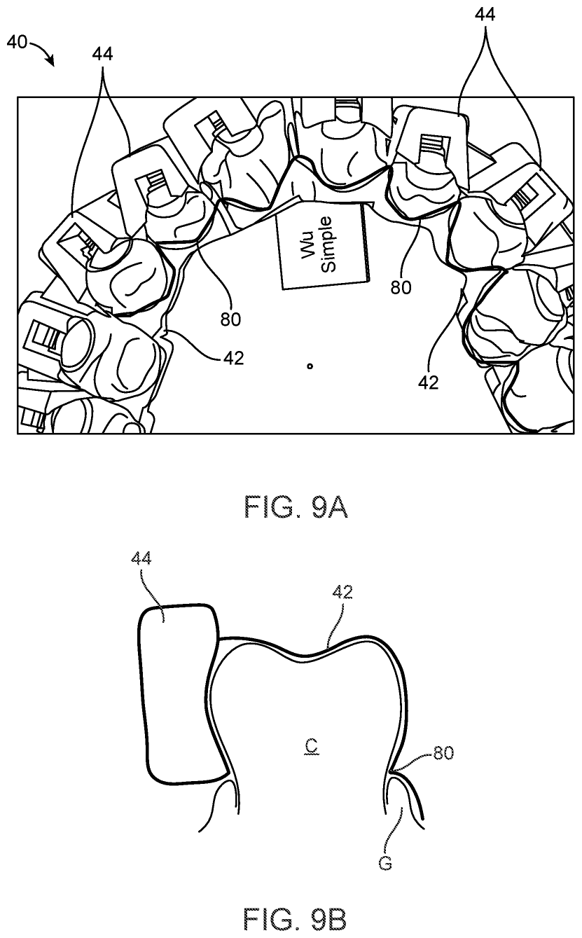

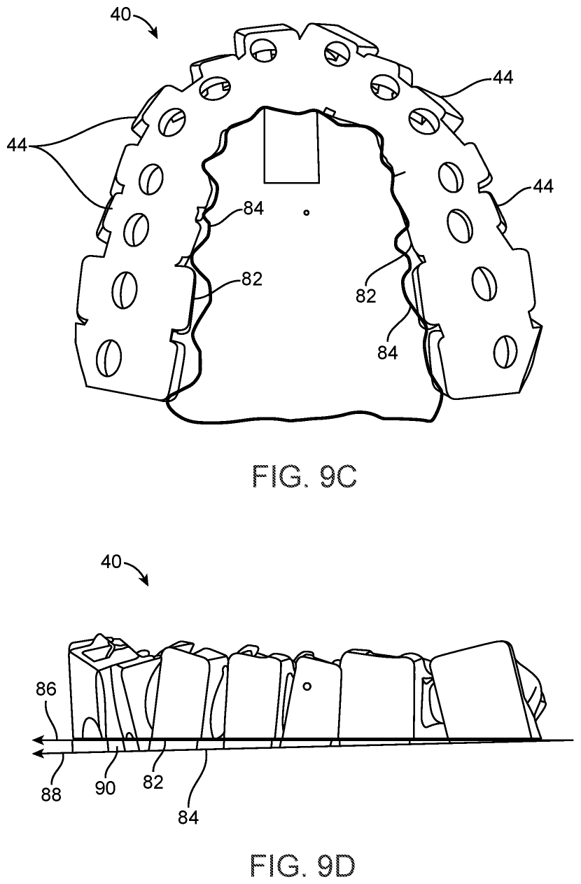

Yet another feature of the hybrid IDB tray 40 which may be optionally incorporated relates to the edge of the tray interface 80 with the gingival margin along the lingual side of the patient's dentition. FIG. 9A shows a bottom detail view of the tray interface 80 along the gingival margin of the lingual side and FIG. 9B shows a partial cross-sectional side view illustrating how the edge of the tray interface 80 is configured to follow and interface with the gingival margin. The crown C generally forms a natural undercut along the gingival margin as illustrated between the crown C and gums G in FIG. 9B. The hybrid IDB tray 40 may be configured and designed to follow the specific gingival interface of the patient along the lingual side such that the hybrid IDB tray 40 forms a tray interface 80 which curves to interface against the natural undercut and follows along the gingival interface.

This tray interface 80 helps to secure the hybrid IDB tray 40 into this natural undercut and further allows for a reduction in the amount of material used to form the hybrid IDB tray by keeping the hybrid IDB tray 40 relatively thinner along the lingual side of the tray 40 than would the amount of material which would normally be used by an orthodontic shell.

Lingual Profile Reduction

Another feature that the hybrid IDB tray 40 may incorporate is illustrated in the top and side views of FIGS. 9C and 9D which shows how the lingual profile of the hybrid IDB tray 40 may be further reduced. As shown in FIG. 9C, the occlusal side of the hybrid IDB tray 40 is illustrated with the curvature 84 representing the amount of material which would normally be used to create an orthodontic shell and the curvature 82 representing the resulting margin along the occlusal surface which is actually used in forming the hybrid IDB tray 40.

In reducing the amount of material along the lingual side of the hybrid IDB tray 40, the securement of the hybrid IDB tray 40 may be facilitated by the tray interface 80 taking advantage of the natural undercut along the gingival margin described above. The amount of material along the occlusal surface of the hybrid IDB tray 40 may be determined by forming a line or initial plane 88 (such as a horizontal plane of the hybrid IDB tray 40) along the occlusal surfaces, as illustrated in the side view of FIG. 9D. This initial plane 88 may be angled from the incisors to the molars to reposition the plane 86 such that the difference between angled plane 86 and initial plane 88 may represent the amount of material 90 which may be removed from the hybrid IDB tray 40 resulting in an appliance having a reduced amount of material without a reduction in performance. In this manner, the occlusal surface of the hybrid IDB tray 40 may remain flattened while the amount of material along the incisors may be removed in greater amounts than the amount of material along the molars.

While the planes are illustrated as having been angled from the incisors to the molars, the planes may be angled in the opposite direction from the molars to the incisors in other variations such that relatively more material is removed along the molars rather than the incisors of the hybrid IDB tray 40. Yet another variation may have the plane simply adjusted uniformly rather than at an angle to reduce the amount of material along the entire occlusal surfaces of the hybrid IDB tray 40.

Rigidity Via Adjusted Thicknesses

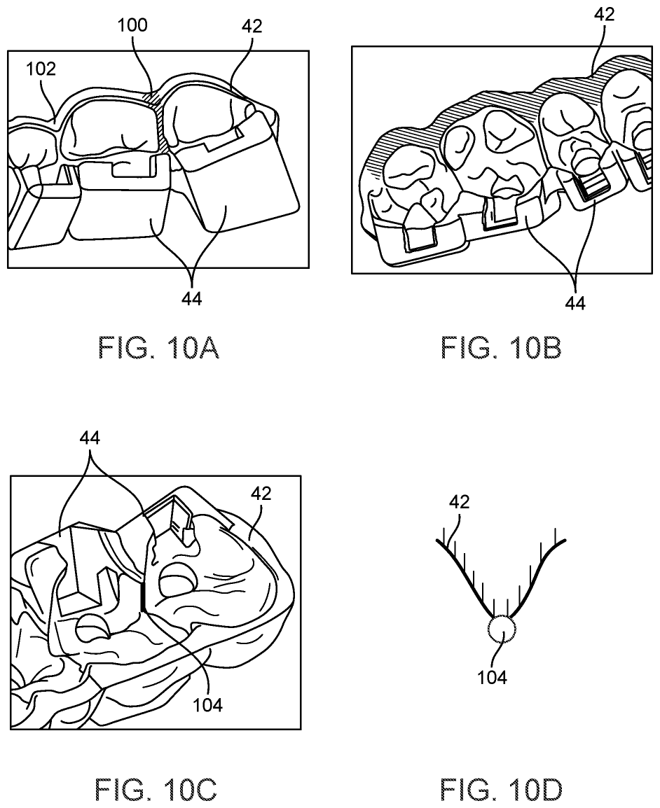

With individual modules 44 aligned adjacently along the orthodontic shell 42, the hybrid IDB tray 40 may be adjusted in its rigidity, for instance, either its overall rigidity or along specified regions of the orthodontic shell 42 in between adjacent modules 44. FIG. 10A illustrates a detail perspective view of the hybrid IDB tray 40 to show how portions of the hybrid IDB tray 40 may be varied in rigidity. In this variation, the portion 100 along the lingual side of the orthodontic shell 42 between adjacent modules 44 may be reduced in thickness to reduce the local rigidity of the orthodontic shell 42 to increase flexibility and comfort for the patient. As the portions of the orthodontic shell 42 between the modules may impart a minimal amount of force upon the adjacent crowns, the thickness of the portion 100 may be reduced relative to the thickness of the rest of the orthodontic shell 42 so that the portions of the orthodontic shell 42 which contact the dentition may flex by a greater amount than if the thickness remained unchanged along portion 100.

One or more regions of the hybrid IDB tray 40, e.g., along the lingual side, may be varied in thickness to have relatively thinner regions and/or relatively thicker regions such that the flexibility of the orthodontic shell 42 and hybrid IDB tray 40 may be adjusted to become more rigid and/or less rigid overall or more rigid and/or less rigid along select regions depending upon the desired flexibility. For instance, while region 100 may be reduced in thickness, another region 102 may be similarly reduced in thickness by the same amount or a different amount and the hybrid IDB tray 40 may incorporate one or more regions having varied thickness, as desired.

Another variation is shown in the detailed perspective view of FIG. 10B which illustrates how the thickness of the orthodontic shell 42 itself may be adjusted, e.g., reduced, along the entire length of the orthodontic shell 42 to increase the overall flexibility of the orthodontic shell 42. Alternatively, select portions of the orthodontic shell 42 may be reduced along its length relative to adjacent portions, as noted above, to adjust the flexibility along specified portions of the orthodontic shell 42.

Additionally and/or alternatively, the portions of the orthodontic shell 42 which extend between the adjacent crowns may be configured to closely follow the dentition along both the buccal and lingual sides of the orthodontic shell 42. With the orthodontic shell 42 following the anatomy of the patient's dentition, additional features may be incorporated or defined along the inner walls of the orthodontic shell 42 to ensure retention of the orthodontic shell upon the dentition. FIG. 10C illustrates a perspective view of the orthodontic shell 42 and modules 44 and the portions of the orthodontic shell 42 which extend between the interproximal regions of the teeth. One or more of these interproximal regions may also incorporate a retention feature 104 which may extend along the region and project away from the orthodontic shell wall such that the retention feature 104 abuts between the two adjacent surfaces of the crowns to further secure the hybrid IDB tray 40 relative to the teeth.

FIG. 10D illustrates an example in the detail top view of how the retention feature 104 may project away from the orthodontic shell wall for contact within the interproximal regions. While the retention feature 104 is shown as having a curved surface, the feature 104 may present any number of shapes which are conducive for securement within the interproximal regions of the teeth. Moreover, the feature 104 may extend along the entire length of the interproximal region or just a portion and the feature 104 may be defined along any one or more of the regions along the orthodontic shell 42. For example, in a region where adjacent teeth may have a relatively larger gap, such a feature 104 may be incorporated to ensure that the orthodontic shell 42 is secured within the gap. Any of the retention features 104 may also be incorporated as part of the hybrid IDB tray material itself or any of the retention features 104 may be attached as a separate element within the hybrid IDB tray 40.

Flattened Occlusal Base

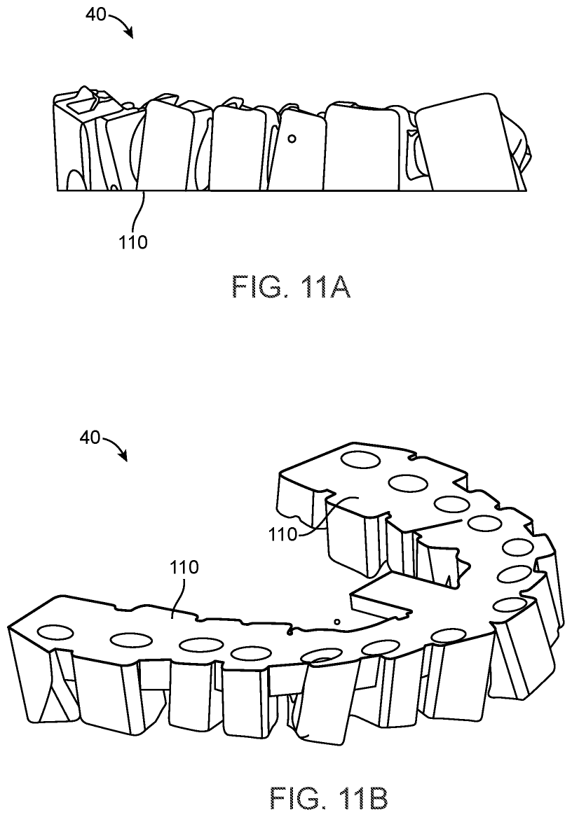

As the hybrid IDB tray 40 may be fabricated through, for instance, additive manufacturing such as three-dimensional printing, the hybrid IDB tray 40 may be formed to have a flattened surface 110, as shown in the side and perspective views of FIGS. 11A and 11B. The flattened surface 110 may facilitate the additive printing process as the hybrid IDB tray 40 may be fabricated upon a platform allowing for the hybrid IDB tray 40 to be built up from the flattened surface 110. As the hybrid IDB tray 40 may be used to accurately position and secure orthodontic devices such as brackets upon the surfaces of the teeth, the occlusal surfaces of the hybrid IDB tray 40 may be formed to have the flattened surface 110 common to the entire hybrid IDB tray 40 as the hybrid IDB tray 40 may be removed from the patient's dentition once the bracket pads have been secured to the teeth.

Occlusal Retentive Feature in Cavity

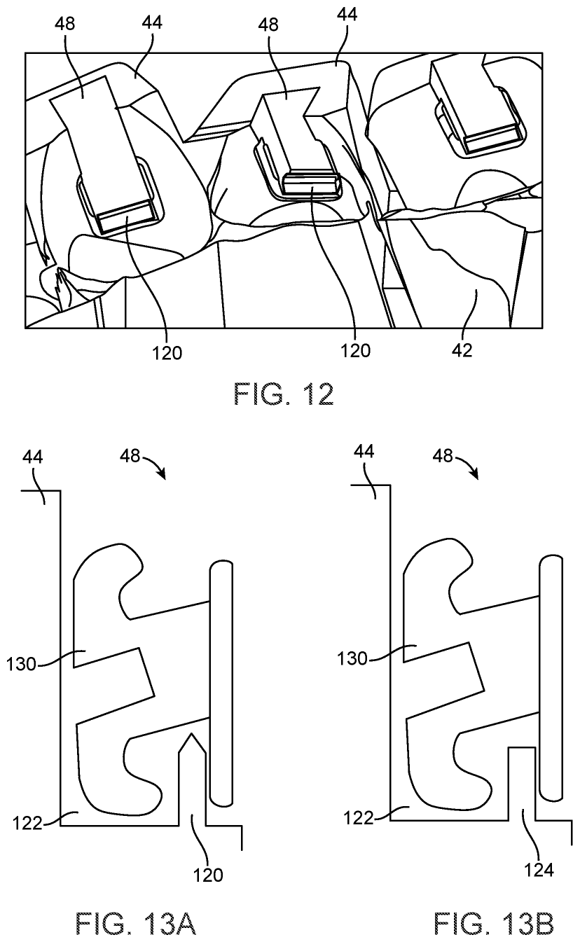

As previously described herein, each of the individual modules 44 may be formed to create a recess 48 within which each respective bracket pad may be securely held for placement upon the patient's crowns. Because the modules 44 may be customized for each patient's anatomy and individual treatment plan, the recesses 48 may be accordingly customized for various different bracket types where the bracket types can be varied along the same hybrid IDB tray 40. As illustrated in the detail perspective view of FIG. 12, one or more recesses 48 within the modules 44 may optionally incorporate an occlusal retention feature 120 designed for maintaining a position of the bracket 130 within the recess 48 and relative to the crown surface for positioning and securement. The occlusal retention feature 120 may be configured specifically for a particular style of bracket 130, if desired.

The occlusal retention feature 120 may be positioned along an occlusal surface within the recess 48 and project proximally (e.g., in a gingival direction or towards the gingiva when in use) to form a shoulder or tapered surface which provides a retention region 122 for securement against the bracket pad 130, as shown in the side views of FIGS. 13A and 13B. The retention feature 120 may secure a position of the bracket pad 130 within the recess 48 during placement and securement against the crown surface. Once the bracket pad 130 has been secured to the dentition, the retention feature 120 may slide away from the bracket 130 to release the bracket 130 and allow for the removal of the hybrid IDB tray 40 from the patient's teeth. The retention feature 120 is illustrated in FIG. 13A as having a tapered distal end to facilitate the insertion and removal of the bracket pad 130 from the retention region 122 but other variations of the retention feature 124 may present a flattened retention surface as illustrated in FIG. 13B. Other variations may be used to facilitate the insertion of the bracket pad 130 as well as release of the bracket pad 130 from the retention feature as well.

Access Lumen

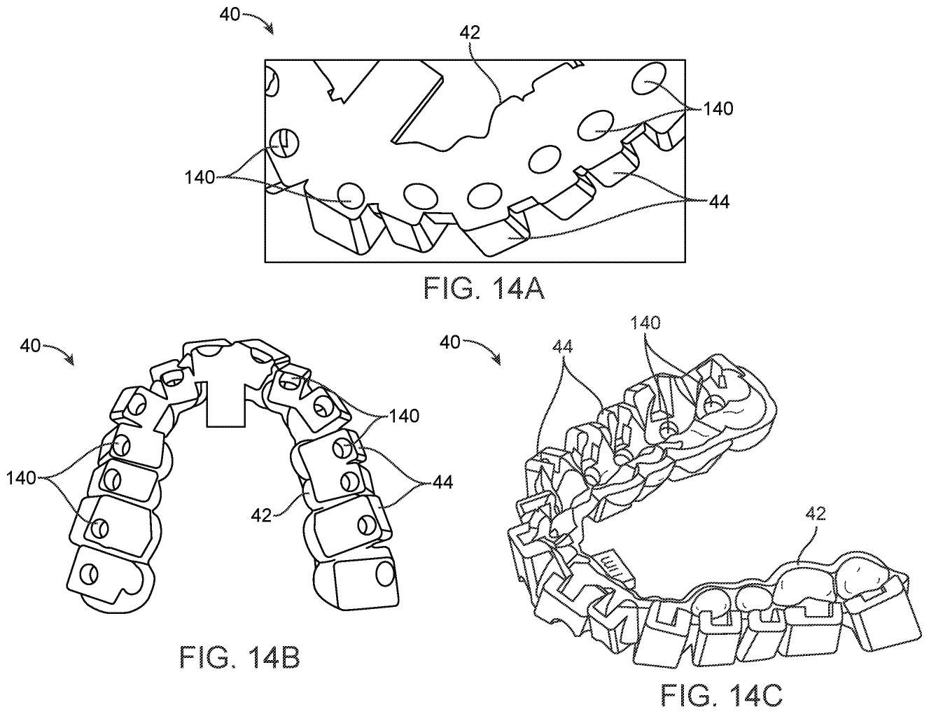

Similar to the access lumen 34 defined through the occlusal plane OP described above in FIG. 4A, the hybrid IDB tray 44 may similarly define access lumens 140 along the occlusal flattened surface 110, as shown in the detail top and bottom perspective views of FIGS. 14A and 14B. The access lumens 140 may be defined along the occlusal surface of each module 44 for providing access to within the recess 48, for example, for providing access to a bracket or other orthodontic appliance contained within when the access tray 40 is positioned upon the patient's teeth.

FIG. 14C illustrates a perspective bottom view of the hybrid IDB tray 40 and modules 44 showing how the access lumens 140 may extend through the occlusal flattened surface 110 and through the orthodontic shell 42 of each module 44. One or more instruments may be introduced through the access lumen 140 for accessing the bracket pad contained within for any number of procedures such as adjusting a bracket, cleaning the bracket or excess adhesive, facilitating removal of the hybrid IDB tray 40 from a bracket and/or from the teeth of the patient, etc.

Base Layer Filleting

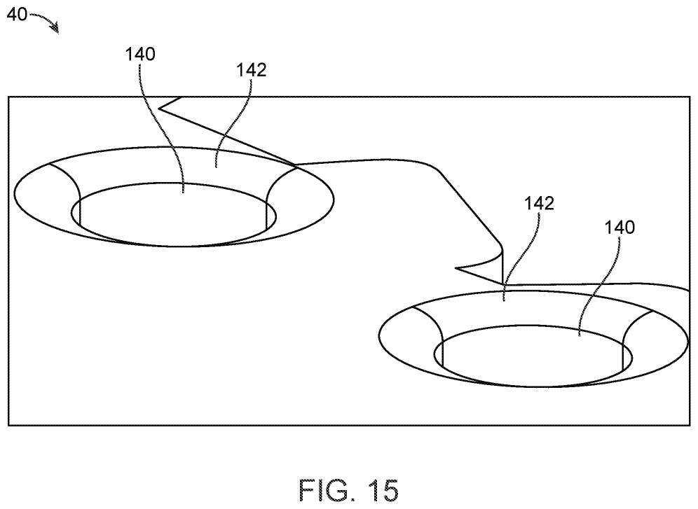

As shown in the perspective view of FIG. 15, each of the access lumens 140 may have its edges 142 optionally angled or filleted to create a curved interface. The base layer filleting may be digitally created so as to created the fillets or chamfer in order to improve the printability of the hybrid IDB tray 40.

As each of the edges and openings along the hybrid IDB tray 40 may be configured to create a fillet to increase printability, the overall reduction of material also reduces the base-layer flash material in fabricating the tray 40. Moreover, the curved edges may also facilitate instrument entry and removal from the access lumens 140.

Gingival Access Through Bracket Cavity

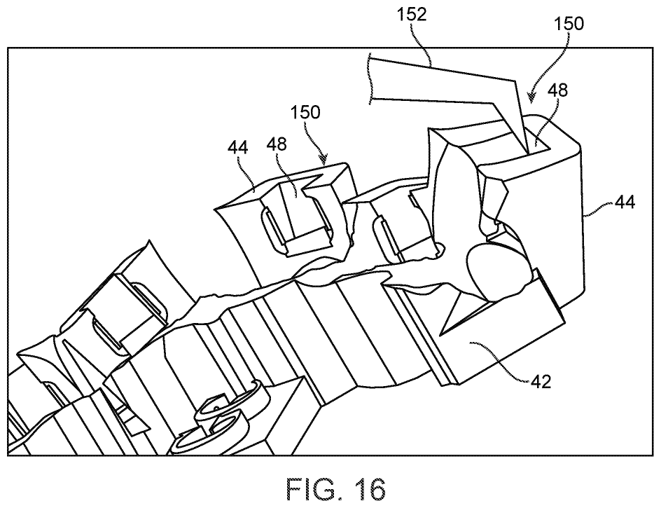

As illustrated in the detail perspective view of FIG. 16, as well as other figures herein, each of the modules 44 may define an access opening 150 along a gingival side opposite to the occlusal flattened surface 110 to allow access within the recess 48 for any number of instruments 152. Some or all of the modules 44 along the hybrid IDB tray 40 may include the access opening 150.

Furthermore, the access openings 150 may be sized to allow for the bracket pad within to pass through the access opening 150 as the hybrid IDB tray 40 is removed from the patient dentition. If the access opening 150 is sized relatively smaller than the bracket positioned within the recess 48, the module 44 may be flexed partially away from the bracket pad during removal of the hybrid IDB tray 40 using, for instance, an instrument 152.

Segmentability

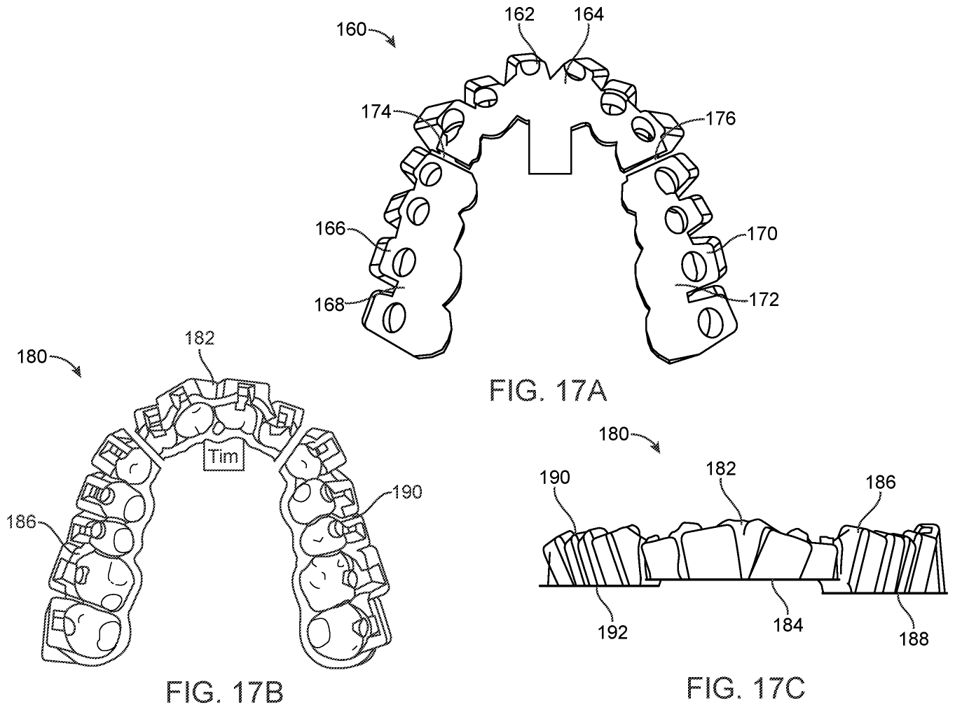

While the hybrid IDB tray may be fabricated as a complete singular appliance, other variations may include hybrid IDB trays which are fabricated as two or more separate components. FIG. 17A shows a top view of one variation where an hybrid IDB tray assembly 160 may include several hybrid IDB tray segments 162, 166, 170 which collectively form an entire hybrid IDB tray 160. The hybrid IDB tray segments 162, 166, 170 may be digitally separated along separation planes 174, 176 which divide each of the hybrid IDB tray segments 162, 166, 170 from one another. Furthermore, the separation planes 174, 176 may be located between any of the teeth and while three individual segments are shown in this variation, other variations may have the hybrid IDB tray assembly 160 separated into two separate segments or more than three segments as desired.

Having the hybrid IDB tray assembly 160 separated into different segments allows for the individual segments to reduce the plane thickness which in turn helps to improve the handling of the individual segments for placement upon the teeth and removal from the teeth. For instance, the amount of material removed from the individual occlusal planes 164, 168, 172 may be uniform between each of the segments 162, 166, 170 or they may be varied between one or more of the segments resulting in varying heights.

FIGS. 17B and 17C show another bottom and front views of another variation of an hybrid IDB tray assembly 180 where individual hybrid IDB tray segments 182, 186, 190 are each formed with occlusal plane heights which are different from one another. For instance, occlusal plane 184 of a first segment 182 may be formed with a relatively low height due to more material being removed from the occlusal plane 184 while the occlusal plane 188 of a second segment 186 may be formed with a relatively high height due to more material remaining in the fabrication of the segment 186 while the occlusal plane 192 of a third segment 190 may be formed with a relatively intermediate height between the occlusal planes 184, 188.

The relative heights of the occlusal planes of different segments may be varied depending upon the amount of material desired or needed for fabrication of the individual segment without sacrificing hybrid IDB tray performance. Hence, the different occlusal planes may be varied between the individual segments to be uniform or differing between one another. While the different occlusal planes may be determined and varied manually, the different height values may also be calculated automatically and set using software such as that available through uLab Systems, Inc.

Identification Labeling

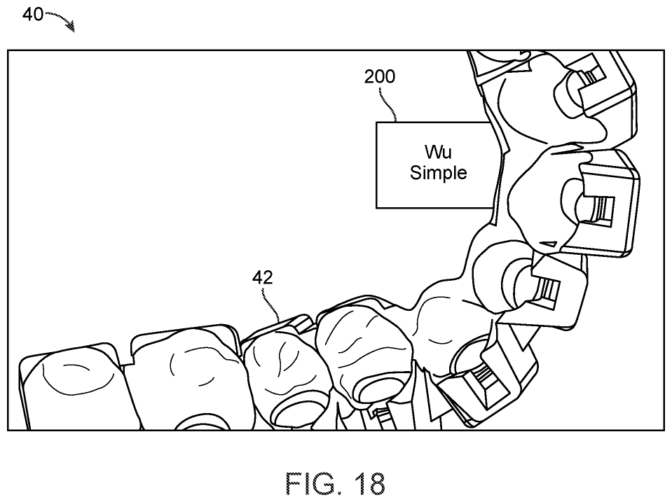

In any of the variations described, the hybrid IDB tray 40 may optionally incorporate an identification platform 200 which may be fabricated as an integrated part of the hybrid IDB tray 40 or as a separate identification platform 200 which may be attached to a particular hybrid IDB tray 40, as shown in the top view of FIG. 18. In this variation, the identification platform 200 is illustrated as an integrated platform which extends from an anterior portion of the hybrid IDB tray 40 along a lingual portion such that the surface of the platform 200 extends along the occlusal surface of the hybrid IDB tray 40.

The surface of the identification platform 200 may provide a place for identifying information to be displayed such as patient information, hybrid IDB tray information, etc.

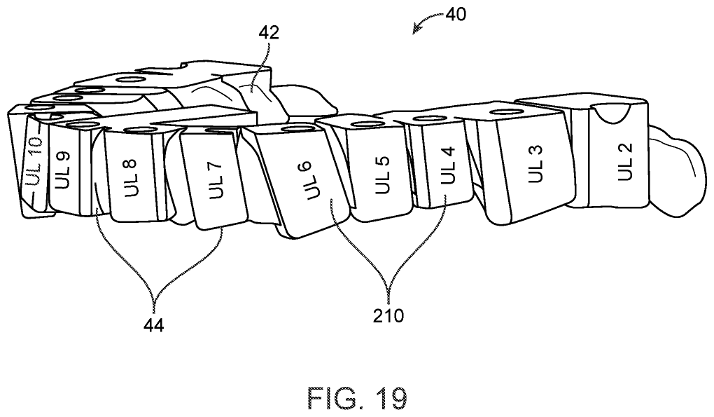

Additionally and/or alternatively, the buccal and/or lingual surfaces of the modules 44 may optionally include identifying information 210 which may be engraved, embossed, or otherwise adhered for the tooth identification match and/or bracket match with that particular module. FIG. 19 illustrates a perspective view of hybrid IDB tray 40 having modules 44 with identifying information 210 provided on the exterior of the modules 44 to identify the corresponding tooth upon which the module 44 is placed. Other information may also be provided as desired.

Hybrid IDB Tray Combinations

While individual features of the hybrid IDB tray are described in different embodiments, this is done for clarity purposes as any of the hybrid IDB trays described may incorporate any one or all of the various features described herein in a single hybrid IDB tray.

Alternatively, an hybrid IDB tray may be designed and/or fabricated to incorporate any combination of the features described herein. For instance, a single hybrid IDB tray may incorporate all of the features: hybrid IDB tray additive Boolean, dimpled securement feature, best fit bite plane, lingual gingival margin coverage, lingual profile reduction, adjusted thicknesses, flattened occlusal base, occlusal retentive feature in cavity, access lumens, base layer filleting, gingival access through bracket cavity, segmented components, identification labeling, etc.

Another variation may incorporate any combination of the individual features so that a singular orthodontic shell may incorporate any one or more of the following features: hybrid IDB tray additive Boolean, dimpled securement feature, best fit bite plane, lingual gingival margin coverage, lingual profile reduction, adjusted thicknesses, flattened occlusal base, occlusal retentive feature in cavity, access lumens, base layer filleting, gingival access through bracket cavity, segmented components, identification labeling, etc.

Such a combination may incorporate any one, two, three, or more of the features in a single orthodontic shell as desired or necessary and any of the features may be optionally included or omitted as desired or necessary.

Furthermore, variations show the modules formed along the buccal surfaces of the orthodontic shell such that the recesses open against the buccal surfaces of the orthodontic shell. However, other variations may incorporate the modules formed along the lingual surfaces of the orthodontic shell such that the recesses open against the lingual surfaces of the orthodontic shell. Additional variations may include an aligner having modules formed along both buccal and lingual sides of the orthodontic shell or where an orthodontic shell may include some modules formed along select buccal sides and other modules formed along select lingual sides of the same orthodontic shell depending upon the selected treatment. These variations of buccal and/or lingual positioned modules may be used in any combination with any of the features as described above such that different embodiments are contemplated with the above combinations to include both buccal and/or lingual positioned modules.

The applications of the devices and methods discussed above are not limited to the one described but may include any number of further treatment applications. Modification of the above-described assemblies and methods for carrying out the invention, combinations between different variations as practicable, and variations of aspects of the invention that are obvious to those of skill in the art are intended to be within the scope of the claims.

What is claimed is:

1. An hybrid IDB tray apparatus, comprising:
an orthodontic shell configured to conform to a dentition of a patient; and
one or more modules incorporated along the orthodontic shell and where each of the one or more modules defines a recess configured to removably retain a bracket such that each recess opens along the orthodontic shell to position the bracket against a surface of a crown.

2. The apparatus of claim 1 wherein the orthodontic shell defines a tray interface configured to follow a gingival margin when the hybrid IDB tray is positioned upon the dentition.

3. The apparatus of claim 1 wherein the one or more modules each define an access lumen through an occlusal surface of each module.

4. The apparatus of claim 3 wherein an edge of the access lumen presents a curved or filleted interface.

5. The apparatus of claim 1 wherein the one or more modules each define an access opening through a gingival side opposite to an occlusal surface of each module.

6. The apparatus of claim 5 wherein the access opening is sized to allow for the bracket to pass through.

7. The apparatus of claim 1 wherein the orthodontic shell defines one or more securement features along an inner surface of a receiving cavity of the orthodontic shell for securement against a surface of the dentition.

8. The apparatus of claim 7 wherein the one or more securement features comprise a recess, protrusion, projection, or dimple.

9. The apparatus of claim 1 wherein the orthodontic shell is configured to follow a best fit bite plane of the dentition.

10. The apparatus of claim 1 wherein the orthodontic shell is configured to present an occlusal surface which is angled relative to a horizontal plane of the hybrid IDB tray whereby an amount of material of the hybrid IDB tray is reduced.

11. The apparatus of claim 1 wherein the orthodontic shell comprises reduced portions between adjacent modules having a thickness which is relatively less than a thickness of the orthodontic shell.

12. The apparatus of claim 1 wherein the hybrid IDB tray presents an occlusal surface which is configured to be flattened.

13. The apparatus of claim 1 wherein the recess of the one or more modules comprises an occlusal retention feature configured to maintain a position of the bracket within the recess.

14. The apparatus of claim 1 wherein the hybrid IDB tray is comprised of two or more separate tray segments which collectively form the hybrid IDB tray.

15. The apparatus of claim 14 wherein each of the tray segments comprises an occlusal plane having a height.

16. The apparatus of claim 15 wherein a first height of a first occlusal plane of a first tray segment is different from a second height of a second occlusal plane of a second tray segment.

17. The apparatus of claim 1 further comprising an identification platform attached to the hybrid IDB tray.

18. A method of forming an hybrid IDB tray, comprising:
receiving three-dimensional scanned data relating to a dentition of a patient to form a corresponding digital model of the dentition;
determining a position of one or more brackets for placement upon the digital model of the dentition;
digitally forming an orthodontic shell configured to conform to the dentition;
digitally forming one or more modules corresponding to the position of the one or more brackets upon the dentition; and
incorporating the one or more modules with the orthodontic shell to form an hybrid IDB tray.

19. The method of claim 18 further comprising fabricating the hybrid IDB tray.

20. The method of claim 18 wherein incorporating the one or more modules with the orthodontic shell comprises forming a tray interface configured to follow a gingival margin relative to the dentition.

21. The method of claim 18 wherein digitally forming one or more modules further comprises forming an access lumen through an occlusal surface of each of the one or more modules.

22. The method of claim 21 wherein forming the access lumen comprises configuring the access lumen to have a curved or filleted interface.

23. The method of claim 18 wherein digitally forming one or more modules further comprises forming an access opening through a gingival side opposite to an occlusal surface of each of the one or more modules.

24. The method of claim 23 wherein the access opening is sized to allow for the bracket to pass through.

25. The method of claim 18 wherein digitally forming the orthodontic shell further comprises forming one or more securement features along an inner surface of a receiving cavity of the orthodontic shell for securement against a surface of the dentition.

26. The method of claim 25 wherein the one or more securement features comprise a recess, protrusion, projection, or dimple.

27. The method of claim 18 wherein digitally forming the orthodontic shell further comprises configuring the orthodontic shell to follow a best fit bite plane of the dentition.

28. The method of claim 18 wherein digitally forming one or more modules further comprises forming reducing a thickness of the orthodontic shell between adjacent modules.

29. The method of claim 18 wherein digitally forming one or more modules further comprises forming an occlusal surface to have a flattened surface.

30. The method of claim 18 wherein digitally forming one or more modules further comprises forming an occlusal retention feature within a recess defined within the one or more modules to maintain a position of the one or more brackets within a corresponding recess.

31. The method of claim 18 further comprising separating the hybrid IDB tray into two or more separate tray segments which collectively form the hybrid IDB tray.

32. The method of claim 31 wherein each of the tray segments comprises an occlusal plane having a height.

33. The method of claim 32 wherein a first height of a first occlusal plane of a first tray segment is different from a second height of a second occlusal plane of a second tray segment.

34. The method of claim 18 further comprising forming an identification platform attached to the hybrid IDB tray.
